(19) United States
(12) Patent Application Publication
(10) Pub. No.: US 2017/0110803 A1
(43) Pub. Date: Apr. 20, 2017

(54) DEPLOYABLE REFLECTARRAY HIGH GAIN ANTENNA FOR SATELLITE APPLICATIONS

(71) Applicant: CALIFORNIA INSTITUTE OF TECHNOLOGY, Pasadena, CA (US)

(72) Inventors: Richard E. HODGES, PASADENA, CA (US); Daniel J. HOPPE, PASADENA, CA (US); Phillip E. WALKEMEYER, PASADENA, CA (US); Vinh M. BACH, PASADENA, CA (US); Nacer E. CHAHAT, PASADENA, CA (US); Jonathan SAUDER, PASADENA, CA (US); Armen S. TOORIAN, PASADENA, CA (US); Matthew J. RADWAY, PASADENA, CA (US); Long Y. CHEN, PASADENA, CA (US)

(21) Appl. No.: 15/204,951

(22) Filed: Jul. 7, 2016

Related U.S. Application Data
(60) Provisional application No. 62/190,161, filed on Jul. 8, 2015.

(51) Int. Cl. H01Q 15/16; H01Q 21/06; H01Q 1/28

(52) U.S. Cl. CPC H01Q 15/162; H01Q 1/288; H01Q 21/065

(57) ABSTRACT

A reflectarray antenna comprises panels connected by rotating hinges. The panels are stowed folded around a satellite body and deploy by actuating the spring loaded hinges to extend and form a reflectarray for operation in the K/Ka or X-band. The feed deploys from the satellite body to allow formation of a high gain reflectarray antenna that occupies limited space in small satellite operations.

### CROSS REFERENCE TO RELATED APPLICATIONS

The present application claims priority to U.S. Provisional Patent Application No. 62/190,161, filed on Jul. 8, 2015, the disclosure of which is incorporated herein by reference in its entirety.

### STATEMENT OF INTEREST

The invention described herein was made in the performance of work under NASA contracts NNN12AA01C and is subject to the provisions of Public Law 96-517 (35 USC 202) in which the Contractor has elected to retain title.

### TECHNICAL FIELD

The present disclosure relates to satellite antennas. More particularly, it relates to a deployable reflectarray high gain antenna for satellite applications.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates a diagram of an example of a reflectarray antenna.

FIG. 2 illustrates an example of a deployable antenna.

FIG. 3 illustrates measured ISARA EM antenna patterns at 26 GHz.

FIG. 4 illustrates another example of a deployable antenna.

FIG. 5 illustrates a diagram of another example of a reflectarray antenna.

FIG. 6 shows an exemplary reflectarray panel.

FIG. 7 shows the predicted principal plane radiation patterns for the MarCO antenna.

### SUMMARY

In a first aspect of the disclosure, a structure is described, the structure comprising: structure comprising: a plurality of panels comprising at least a central panel attached to a satellite body through rotating hinges, and at least two winglet panels, each winglet panel attached to a side of the central panel through rotating hinges; and a feed attached to the satellite body, wherein the plurality of panels is configured to actuate from a first configuration to a second configuration, the first configuration being folded around the satellite body and the second configuration being deployed away from the satellite body to thrill a reflectarray antenna.

### DETAILED DESCRIPTION

The present disclosure describes high gain deployable reflectarray antennas to support small satellite (such as CubeSat) telecommunications. One type of reflectarray antenna described herein is the Integrated Solar Array and Reflectarray Antenna (ISARA), a K/Ka-band antenna that also incorporates a dense packing of solar cells used to provide electrical power for the spacecraft. A second type of reflectarray antenna described herein is an X-hand reflectarray designed to provide a bent pipe telecom link. These reflectarrays are ideal for small satellite applications, for example CubeSat applications, because they require negligible stowed volume and impose a modest mass increase,

Small satellites such as CubeSats have seen explosive growth over the past decade and have emerged as a viable alternative to traditional large satellite technology for many applications, see Refs. [1,2]. The CubeSat paradigm of rapid development and low cost enables a new class of missions for a wide range of applications, such as Earth imaging, Earth science sensors and telecommunications. Most CubeSats are launched into Low Earth Orbit (LEO) where a typical pass over a ground station may only permit a 5 minute window to download data. Consequently, missions require high speed telecommunications in order to download the data payload. In addition, recent CubeSat missions have targeted lunar, asteroid and planetary destinations in which a telecom system must contend with very large free space attenuation to achieve even a relatively low data rate.

Meeting the requirements of these communications systems in a CubeSat is a significant challenge due to many factors. The two dominant system parameters are transmit power and antenna gain. Transmit power for most CubeSats is limited to a few Watts due to available solar panel power and significant thermal management issues imposed by amplifier efficiency, which is typically less than 30%, and electronics packaging density. The present disclosure describes an antenna that has a low impact on the spacecraft mass and volume. Consequently, development of a practical High Gain Antenna (HGA) has received considerable attention as an enabling technology for high data rate CubeSat telecom systems.

The fundamental factors for antenna gain G are expressed in the equation

G=4πηAf²/c²,

where η is the antenna efficiency, A is the cross-sectional area, f is the frequency and c is a constant. Since gain increases as f², higher frequency bands are attractive, and telecom systems are currently being developed at X-band and higher frequency bands such as Ka-band for Earth orbiting satellites. For a given frequency band, the goal is then to produce maximum antenna area and efficiency. However, the limited mass and volume available in a CubeSat presents a tremendous HGA design challenge.

CubeSat HGA antenna technologies include, for example, (1) Microstrip patch arrays (MPA) mounted on the side of the spacecraft, (2) Parabolic reflector antennas (PRA) that stow inside the CubeSat, and (3) Folded panel reflectarrays (FPR) that stow on the sides of the spacecraft. A non-deployable MPA offers lower risk, but is of limited interest because the maximum gain is constrained by available surface area on the side of the CubeSat and feed network losses. PRAs currently under development for CubeSats use a traditional “umbrella” style of deployment mechanism and provide broad bandwidth and the promise of high efficiency. However, stowage of these units takes a relatively large fraction of the CubeSat volume. For example, 50 cm diameter KaPDA deployable mesh reflector is expected to achieve 60% efficiency and require a 1.5U stowage volume, see Ref. [3]. FPR reflectarrays can provide a very significant reduction in stowed volume. In some cases, the panels can be stowed entirely within the “dead space” between the bus and the launch canister (e.g. P-POD), so the antenna does not consume any payload volume. These FPR antennas are mechanically simple, depending on a simple spring loaded hinge deployment mechanism, have relatively low mass density, and are expected to have low production cost.

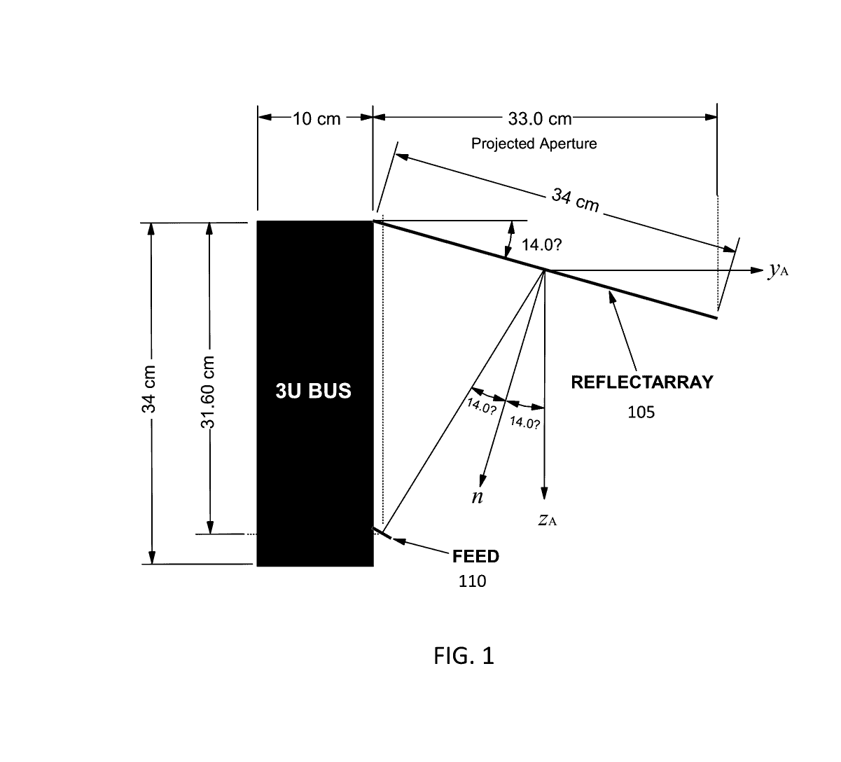

An example of FPR antennas is given by the ISARA mission, see Ref [5]. The ISARA design is particularly unique because it incorporates 24 solar cells on the side of the panels opposite the reflectarray, so it can provide both prime spacecraft power and a high speed datalink. The ISARA design is comprised of three 33.9 cm×8.26 cm reflectarray panels designed to achieve 33.5 dB of gain at 26 GHz. As illustrated in FIG. 1, the feed (110) is mounted on the bus in an offset configuration with a projected aperture of 33 cm×27 cm. The reflectarray panels (105) are canted 14° relative to the bus so that the specular direction of the main beam is parallel to the bus axis, see Ref. [6]. The bus can also be termed, in the present disclosure, as the satellite body.

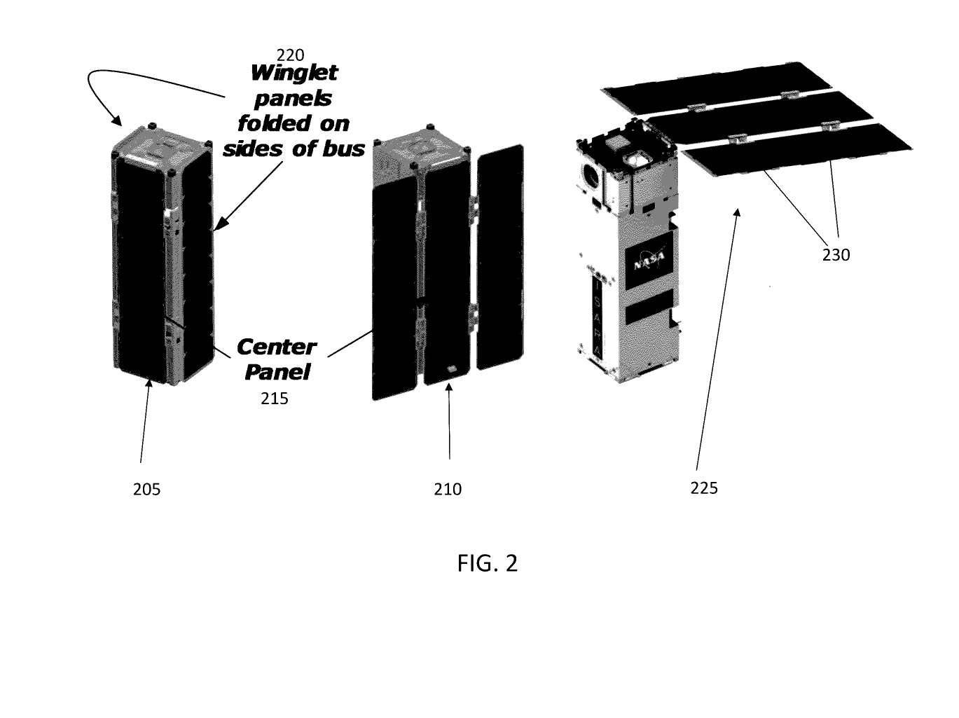

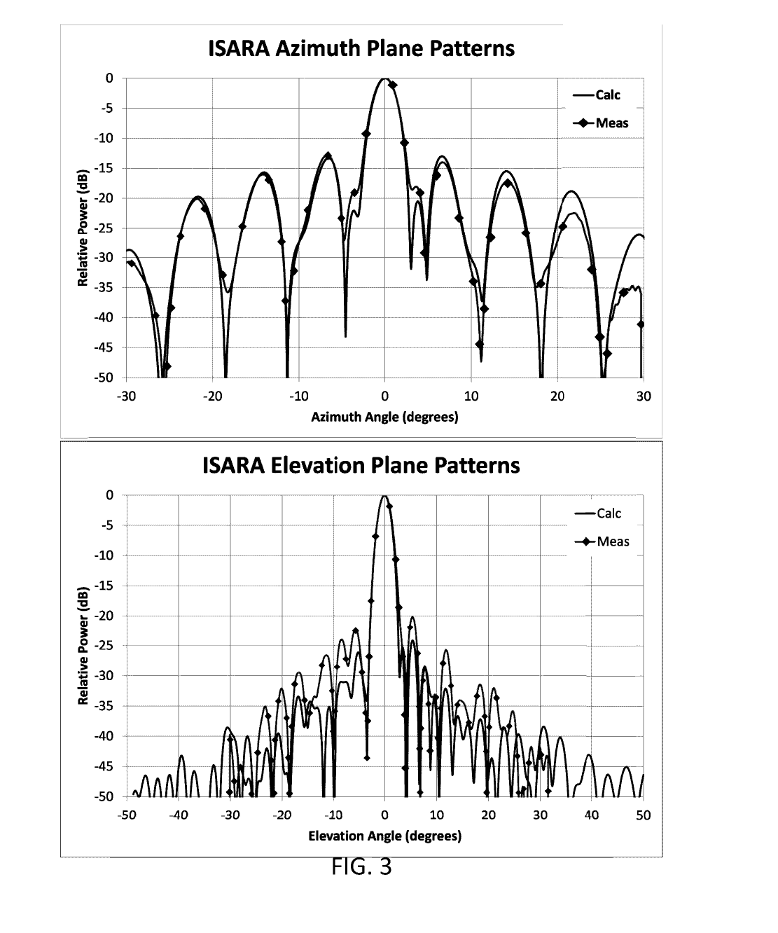

The ISARA antenna comprises panels, feed and hinges. The deployment mechanism, illustrated in FIG. 2, was adapted from a standard Pumpkin, Inc. “Turkey Tail” 3U solar panel design, see Ref. [6]. This entire assembly fits within the volume between the spacecraft and standard P-POD launch canister. In this example, the feed is a thin microstrip patch design that fits beneath the center reflectarray panel and “flips out”, so the feed consumes zero payload volume. In FIG. 3, the panels are shown as stowed when folded around the body of the satellite (205). The panels can be unfolded (210) for deployment, and can comprise a center panel (215) and winglet panels folded on the side of the bus (220). The panels can be moved in the desired position (225) through deployment. The different panels have hinges (230) that allow rotation of the winglet panels. Panel deployment consists in moving the panels from their stowed position to their final operational location. The deployment can be set in motion by a release mechanism and can be driven by the stored potential energy in spring loaded hinges. In other embodiments, other mechanisms could provide the motive force to deploy the antenna.

The requirement to maintain panel flatness with expected heating from solar cells, Earth albedo, etc. can drive the design process. Development of a substrate that provides the stiffness to keep panels flat with the solar cells attached can be challenging due to the mismatch in the coefficients of thermal expansion between the solar cells and the panel substrate material. A unique sandwich substrate material was developed using a co-cure process in which a 48 mil graphite composite structural core is sandwiched between a pair of 15 mil Teflon based dielectric circuit boards. The outer circuit boards have a dielectric constant of 3.00 and low loss tangent (tan δ of about 0.001), which is suitable for high efficiency reflectarray panels.

The electrical design of the reflectarray uses, in this example, square patches arranged on a square grid with an element spacing of 0.46 wavelengths. The feed is a 4×4 element microstrip patch array designed to create approximately −10 dB edge taper in order minimize spillover loss and minimize power incident on the bus. Circular polarization is formed by the feed patch design, whereas the reflectarray is a dual linearly polarized design. In other examples the elements could be of different shapes instead of square. For example, for circular polarization efficiency could be improved by using a rotating split ring element. In other embodiments, the feed could be designed to be dual linear polarization.

FIG. 3 shows the measured principal plane radiation patterns along with the calculated patterns obtained for the EM design. The −13 dB azimuth pattern sidelobes are caused by the large 1.1 cm gaps between the center panel and the two winglet panels, a result of the hinge design used to accommodate the 3U CubeSat bus. Preliminary measurements indicate that the flight antenna will achieve a >33.0 dB gain. The circular polarization requirement imposes practical constraints on the feed array spacing which makes it difficult to achieve an optimal edge taper. In this design, the spillover plus the taper loss is approximately 2.0 dB. In addition, the requirement to package the feed into a thin, inexpensive printed circuit hoard package resulted in about 1.4 dB feed loss. Overall antenna bandwidth easily exceeds the required value of 100 MHz.

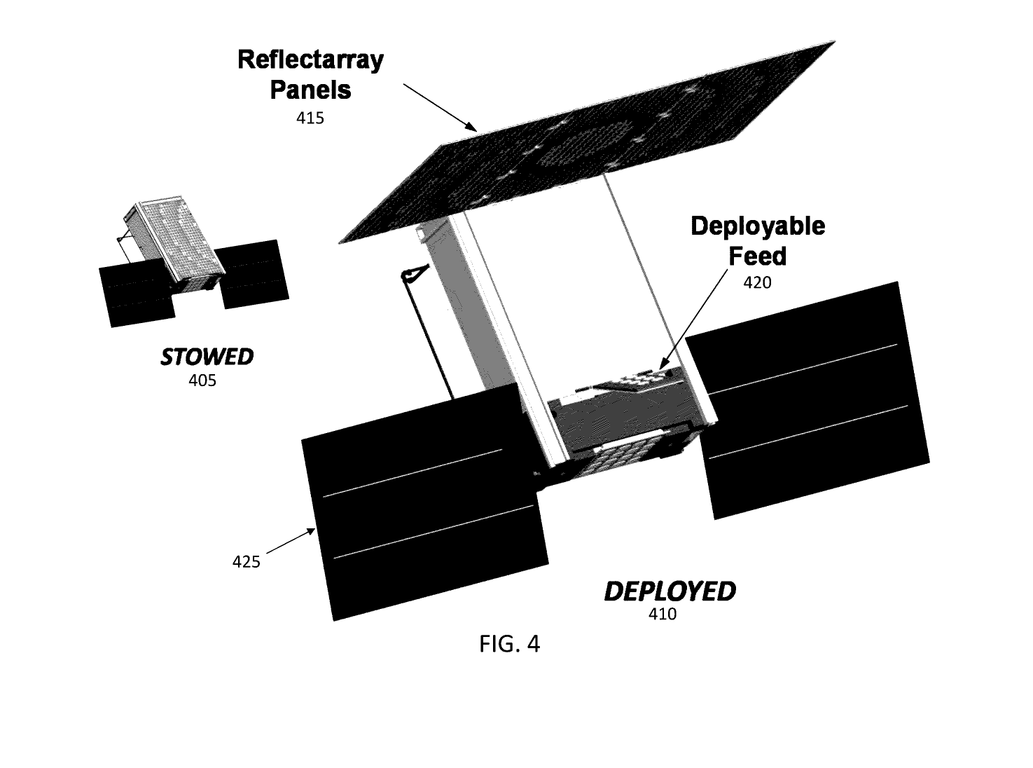

MarCO is a mission that is proposed to fly alongside the InSight mission to Mars in order to provide a bent pipe telecom link to transmit Entry, Descent and Landing (EDL) data to Earth. The proposed spacecraft is a 6U CubeSat which must support both X-hand and UHF telecom systems, power system, battery, attitude sensors, propulsion system, guidance system, on-board computer and avionics. These subsystems consume nearly all of the available 6U volume. In addition, a 28 dB X-band HGA is needed to achieve the downlink data rate requirement. The MarCO FPR illustrated in FIG. 4 was designed to solve this packaging problem.

As illustrated in FIG. 4, the antenna may comprise reflectarray panels that are stowed around the body of the satellite (405). The panels (415) can be deployed (410). The satellite may also comprise solar panels (425) and a deployable feed (420).

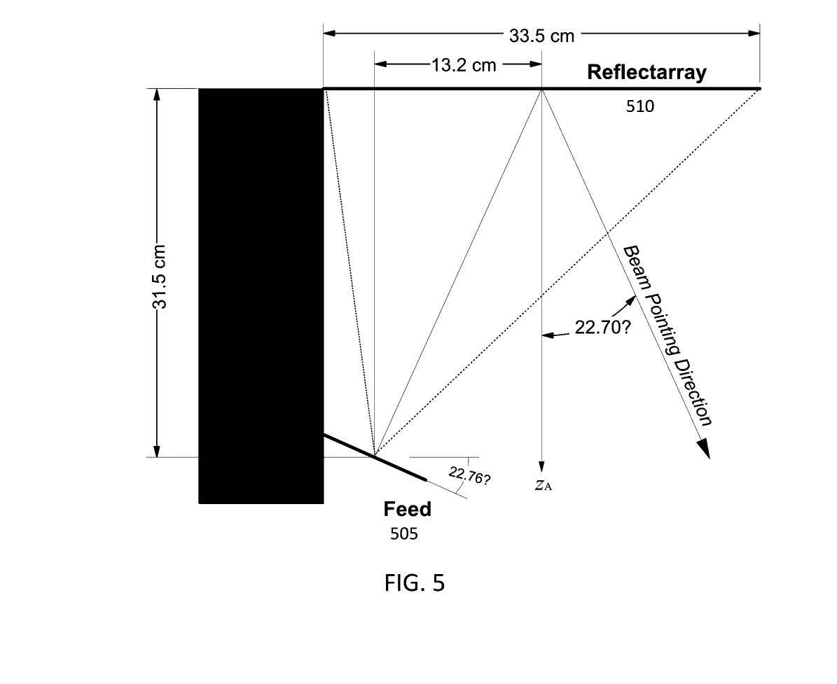

The MarCO antenna, for example, comprises three 33.3 cm×19.9 cm reflectarray panels designed to achieve >28.0 dB gain at 8.425 GHz. As illustrated in FIG. 5, the configuration is similar to ISARA with the feed mounted on the bus. The reflectarray panels deploy perpendicular to the side of the bus so that the main beam is scanned 22.7° from the bus axis, which satisfies a mission pointing requirement. The antenna can be designed to point in a range of pointing angles from zero degrees (pointing in the z-axis direction) to about 45 degrees (although the greater scan angle will reduce gain due to reduced projected aperture area).

As the illustration in FIG. 5 suggests, the antenna stows on the broad face of the spacecraft and deploys through the use of 180° spring loaded winglet hinges and a 90° spring loaded root hinge. The feed (505) is deployed with a spring loaded hinge, is restrained in its stowed position by the reflectarray panels (510) and “flips out” automatically when the panels deploy.

Stowage of MarCO panels proved to be challenging because all three panels are required to stack on one side of the CubeSat and a relatively thick substrate is needed to achieve robust performance at 8.425 GHz. In order to minimize panel thickness, reflectarray patch spacing is reduced to 0.33 wavelengths, which enables one to obtain a practical reflectarray “S-curve” on a much thinner dielectric substrate. The final panel layup consists of two 0.032 inch fiberglass reinforced hydrocarbon ceramic laminate circuit boards co-cured with a central core of graphite composite. The result is a symmetrical panel with a thickness of 0.097 inch that has very high structural rigidity.

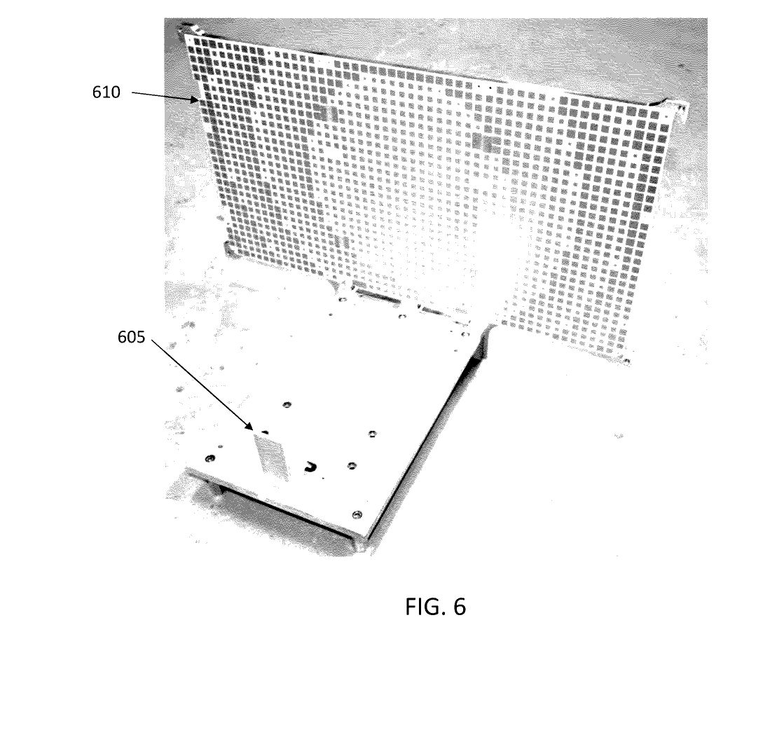

The MarCO reflectarray design uses square patches arranged on a rectangular grid. The 0.33 wavelength element spacing facilitates arrangement of patches on the panels, which is a significant practical problem since there are a relatively small number of patches on these panels. FIG. 6 shows an example of breadboard reflectarray panels (610) The phase wrap pattern of FIG. 6 was adjusted to place hinges and other discontinuities in non-resonant patch locations. The feed (605) is a 4×2 element microstrip patch array designed to create approximately −10 dB edge taper. As with ISARA, circular polarization is formed by the feed patch design and the reflectarray itself is a dual linearly polarized design. In other embodiments, the patches may be of different geometries other than square, such as circular, annulus, split ring or others.

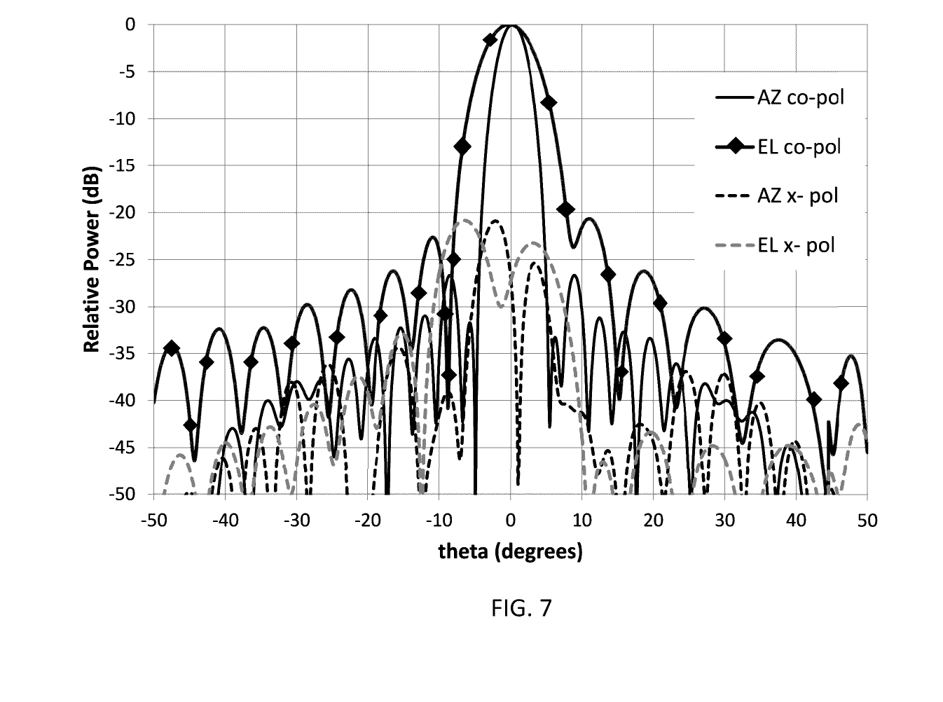

FIG. 7 shows the predicted and measured principal plane radiation patterns for the MarCO antenna. Since the MarCO hinges do not create large panel gaps, azimuth sidelobes are relatively low. The spillover plus taper loss was reduced 1.57 dB, with feed dissipative loss estimated to be 1.25 dB. A detailed gain budget shows the design will achieve >28.0 dB gain. Overall antenna bandwidth exceeds the required value of 100 MHz which provides a useful thermal guard band.

The folded panel reflectarray has great practical value for 3U-6U class CubeSats that need a modest sized HGA. The folded panel reflectarray can also be employed in other small satellite applications due to its high gain, low stowed volume, low production cost and low mass. The ISARA and MarCO designs demonstrate the viability of this concept, although it appears that some improvement in efficiency is possible in both the reflectarray panel and the feed. Nevertheless, the FPR design scalability is limited by the mechanical restrictions of panel flatness and hinge tolerance accumulation, so the technology is complementary with PRA antennas. Finally, for some missions the option to add solar cells to the reflectarray panel could be very useful.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the an are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The references in the present application, shown in the reference list below, are incorporated herein by reference in their entirety.
[1] M. Swartwout, “The First One Hundred CubeSats: A Statistical Look,” J. of Small Satellites, v. 2, no. 2, pp. 213-233, 2013.
[2] M. Swartwout, “The First 272 CubeSats,” EEE Parts for Small Missions Workshop, NASA GSFC, Sep. 11, 2014.
[3] N. Chahat, J. Sauder, M. Thomson, R. Hodges, Y. Rahmat-Samii, “CubeSat Deployable Ka-band Reflector Antenna for Deep Space Missions”, IEEE APS Symp., Vancouver, July 2015.
[4] A. Babuscia, B. Corbin, M. Knapp, R. Jensen-Clem, M. Van de Loo, and S. Seager, “Inflatable antenna for cubesats: Motivation for development and antenna design,” Acta Astronautica, vol. 91, pp. 322-332, October-November 2013, ISSN 0094-5765.
[5] R. Hodges, B. Shah, D. Muthulingham, T. Freeman, “ISARA—Integrated Solar Array and Reflectarray mission overview,” Small Satellite Conference Workshop, Aug. 10, 2013.
[6] cubesatkit.com/docs/datasheet/DS_MISC_3_715-00930-A.pdf, accessed Feb. 20, 2015.

What is claimed is:

1. A structure comprising:
a plurality of panels comprising at least a central panel attached to a satellite body through rotating hinges, and at least two winglet panels, each winglet panel attached to a side of the central panel through rotating hinges; and
a feed attached to the satellite body;
wherein the plurality of panels is configured to change asset from a first configuration to a second configuration, the first configuration being folded around the satellite body and the second configuration being deployed away from the satellite body to form a reflectarray antenna.

2. The structure of claim 1, wherein the rotating hinges are spring loaded.

3. The structure of claim 1, wherein the plurality of panels in the second configuration is canted 14° relative to the satellite body so that a specular direction of a main beam is parallel to the satellite body.

4. The structure of claim 1, wherein the feed is a microstrip patch and is configured to extend out of the satellite body when the plurality of panels is in the second configuration.

5. The structure of claim 1, wherein the plurality of panels comprises a co-cured sandwich substrate material comprising a central structural core of graphite composite sandwiched between a pair of dielectric circuit boards.

6. The structure of claim 5, wherein the central structural core is 48 mm and each dielectric circuit board is 15 mm and a dielectric constant of 3.

7. The structure of claim 1, wherein the plurality of panels comprises square patches arranged on a square grid with an element spacing of 0.46 wavelengths.

8. The structure of claim 1, wherein the feed is a 4×4 element microstrip patch array configured to create −10 dB edge taper in order minimize spillover loss and minimize power incident on the satellite body.

9. The structure of claim 1, wherein the reflectarray antenna is a dual linearly polarized design.

10. The structure of claim 1, wherein the plurality of panels comprises three 33.3 cm×19.9 cm reflectarray panels designed to achieve a gain greater than 28.0 dB at 8.425 GHz.

11. The structure of claim 1, wherein the plurality of panels comprises three 33.9 cm×8.26 cm reflectarray panels designed to achieve a gain of 33.5 dB at 26 GHz.

12. The structure of claim 1, wherein the plurality of panels comprises square patches arranged on a square grid with an element spacing of 0.33 wavelengths.

13. The structure of claim 1, wherein the plurality of panels comprises a co-cured sandwich substrate material comprising a central core of graphite composite sandwiched between two fiberglass reinforced hydrocarbon ceramic laminate circuit boards.

14. The structure of claim 13, wherein the fiberglass reinforced hydrocarbon ceramic laminate circuit boards are 0.032 inch thick.

15. The structure of claim 1, wherein the reflectarray antenna is for operation in the K/Ka band.

16. The structure of claim 1, wherein the reflectarray antenna is for operation in the X band.
